(19) United States
(12) Patent Application Publication
(10) Pub. No.: US 2005/0071474 A1
(43) Pub. Date: Mar. 31, 2005

(54) System for maintaining an active data link layer for ISDN call processing during a software reset operation

(76) Inventors: Ning Lei, Aurora, IL (US); Renato Tramontina, Hilversum (NL)

Correspondence Address: PATTON BOGGS, 1660 LINCOLN ST, SUITE 2050, DENVER, CO, 80264, US

(21) Appl. No.: 10/674,152

(22) Filed: Sep. 29, 2003

(51) Int. Cl. G06F 15/16; H04J 3/16; H04J 3/22

(52) U.S. Cl. 709/227

(57) ABSTRACT

The data link layer maintenance system executes in the Q.921 protocol server of the serving ISDN Access Node and maintains the data link layer active in the ISDN-based Terminal Equipment and the Q.921 protocol server of the serving ISDN Access Node during the execution of a software reset process. This is accomplished by the Q.921 protocol server of the serving ISDN Access Node software storing the data communications connection data in a persistent table that survives the software reset operation. A predetermined set of control signals is then exchanged between the Q.921 protocol server of the serving ISDN Access Node and the ISDN-based Terminal Equipment in response to the initiation of a software reset process to execute standard signaling processes of the LAP-D protocol to force the Terminal Equipment and the Q.921 protocol server of the serving ISDN Access Node into a predetermined stable state.

### FIELD OF THE INVENTION

This invention relates to the field of telecommunications networks that are used to support ISDN functionality.

### PROBLEM

It is a problem in telecommunications networks that support ISDN functionality that during a software reset, also termed a warm-start, the time required to restore normal operation of a software module can exceed the timeout period for the data link layer of the ISDN connection. In particular, the time required to reinitialize and reconfigure each element of the software module can be additive, since much of the restoration process is executed sequentially on each element of the software module. If the overall restoration time is excessive, the ISDN-based Terminal Equipment does not maintain a stable ISDN call connection to the distant party and the call must be reinitiated at the conclusion of the software reset. This adds delay to the data communications session and additional overhead to the telecommunications network as the ISDN call connection must be reestablished.

### SOLUTION

The above described problems are solved and a technical advance achieved by the system for maintaining an active data link layer for ISDN call processing during a software reset operation, termed “data link layer maintenance system” herein. The data link layer maintenance system executes in the LAP-D software of the serving ISDN Access Node and maintains the data link layer active in the ISDN-based Terminal Equipment and the Q.921 protocol server of the serving ISDN Access Node during the execution of a software reset process.

This is accomplished by the Q.921 protocol server of the serving ISDN Access Node software storing the data communications connection data in a persistent table that survives the software reset operation. A predetermined set of control signals is then exchanged between the Q.921 protocol server of the serving ISDN Access Node and the ISDN-based Terminal Equipment in response to the initiation of a software reset process to execute standard signaling processes of the LAP-D protocol to force the Terminal Equipment and the Q.921 protocol server of the serving ISDN Access Node into a predetermined stable state. In particular, the layer 3 of the LAP-D protocol maintains a stable call connection in response to the receipt of a DL-ESTABLISH indication primitive. The data link layer maintenance system therefore stimulates the transmission of this primitive by executing the predetermined set of control signals. The Q.921 protocol server of the serving ISDN Access Node then transmits RNR control signals to the ISDN-based Terminal Equipment, and the ISDN-based Terminal Equipment responds to the Q.921 protocol server of the serving ISDN Access Node with RR control signals for the duration of the execution of the software reset operation to maintain the data link layer active. Once the software reset operation is completed, the data from the persistent table is used to reactivate the held data link layer.

### BRIEF DESCRIPTION OF THE DRAWING

FIG. 1 illustrates in block diagram form the overall architecture of a typical telecommunications network that is used to support ISDN functionality;

FIG. 2 illustrates in block diagram form the overall architecture of a network termination that includes the data link layer maintenance system;

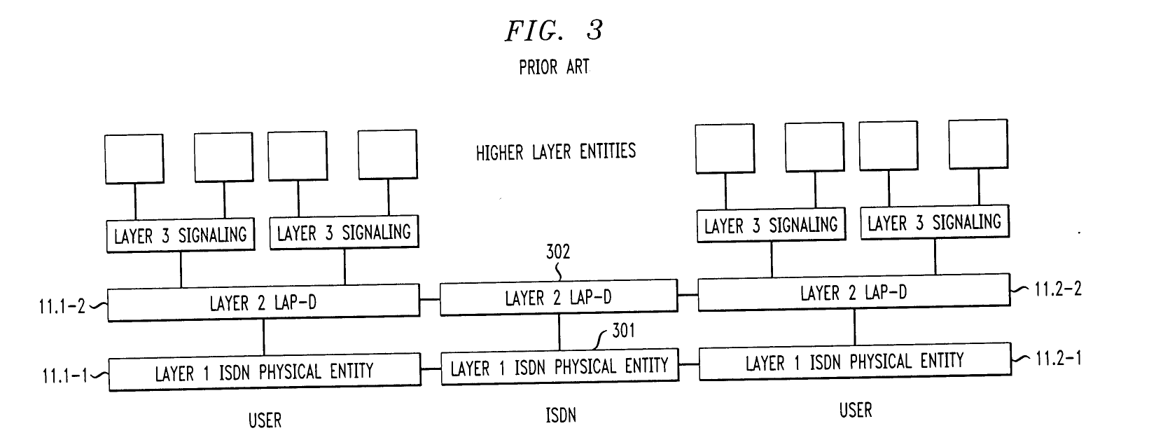

FIG. 3 illustrates in lock diagram form the various protocol layers associated with the exchange of data between two users over a typical telecommunications network that is used to support ISDN functionality; and

FIGS. 4A & 4B illustrate in flow diagram form the operation of the data link layer maintenance system in the telecommunications network of FIGS. 1 to maintain an active data link layer for ISDN call processing during a software reset operation.

### DETAILED DESCRIPTION

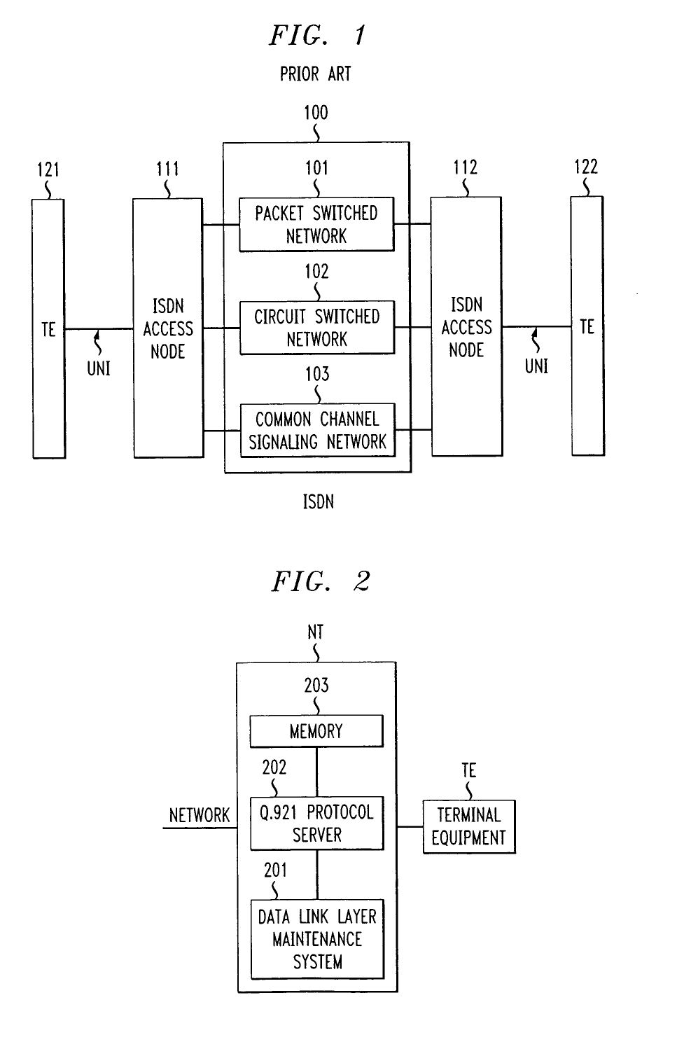

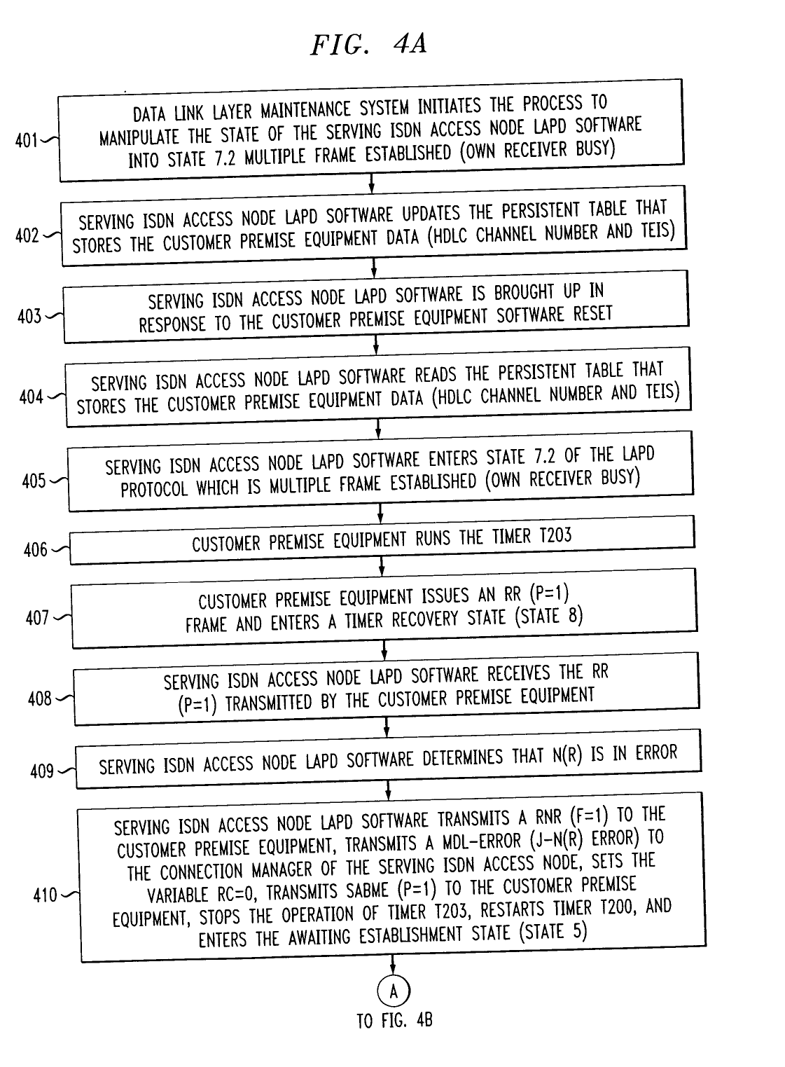

FIG. 1 illustrates in block diagram form the overall architecture of a typical telecommunications network that is used to support ISDN functionality and FIG. 3 illustrates in lock diagram form the various protocol layers associated with the exchange of data between two users over a typical telecommunications network that is used to support ISDN functionality. In particular, a telecommunications network 100 serves to interconnect ISDN Access Nodes 111, 112, each of which serves a plurality of customer terminal equipment 121, 122. The telecommunications network 100 typically includes a circuit switched network 101 and a packet switched network 102 for the transmission of voice and data, respectively. A Common Channel Signaling Network 103 provides the overall control signal transfer functionality to manage the establishment of data and voice communication connections through the telecommunications network 100. The ISDN Access Node 111, 112 typically implements a high speed data channel that is used to carry the voice and data to the terminal equipment 121, 122. A standard multi-layer protocol is used to implement this high speed data channel, also termed Link Access Procedure for a D channel (LAP-D).

The International Telecommunications Union has specified a layer 2 Recommendation (Q.921/I.441) which describes the high level data link (HDLC) procedures commonly referred to as the Link Access Procedure for a Data channel (LAP-D). The objective of layer 2 is to provide a secure, error-free connection between two end-points 111, 112 connected by a physical medium. Layer 3 call control information is carried in the information elements of layer 2 frames and must be delivered in sequence and without error. Layer 2 also has responsibility for detecting and retransmitting lost frames. In LAP-D has also included a feature that makes it possible to multiplex frames by having separate addresses at layer 2, thereby allowing many link access protocols to exist on the same physical connection. It is this feature that allows up to eight terminals to share the signaling channel in the passive bus arrangement. Each layer 2 connection is a separate link access protocol and the termination points for the link access protocols are within the terminals at one end and at the periphery of the exchange at the other. Multiple layer 3 entities are also supported. Discrimination between the data link connections is by means of a Data Link Connection Identifier (DLCI) contained in each frame.

The Q.921/I.441/LAP-D Protocol

Layer 2 operates as a series of frame exchanges between the two communicating, or peer, entities. A fixed pattern, called flag, is used to indicate both the beginning and end of a frame. Two octets are needed for the Q.921 address to carry a Service Access Point Identifier (SAPI), a Terminal Endpoint Identifier (TEI) and a command/response bit. The control field is one or two octets depending on the frame type and carries information that identifies the frame and Q.921 sequence numbers used for link control. The information element is only present in frames that carry layer 3 information and the Frame Check Sequence (FCS) is used for error detection. There is a procedure to avoid imitation of the flag by the data octets. This is achieved by examining the serial stream between flags and inserting an extra 0 after any run of five 1 bits. The receiving Q.921 entity discards a 0 bit if it is preceded by five 1s.

Addressing

Q.921 multiplexing is achieved by employing a separate Q.921 address for each link access protocol in the system. To carry the link access protocol identity the address is two octets long and identifies the intended receiver of a command frame and the transmitter of a response frame. The address has only local significance and is known only to the two end-points using the link access protocol. The address can not be used by the network for routing purposes and no information about its value will be held outside the Q.921 entity. The Service Access Point Identifier (SAPI) is used to identify the service that the signaling frame is intended for. The value of the SAPI is fixed for a given service. The Terminal Endpoint Identifier (TEI) takes a range of values that are associated with terminals on the customer's line. As it is important that no two Terminal Endpoint Identifiers are the same, the network has a special Terminal Endpoint Identifier management entity which allocates Terminal Endpoint Identifiers on request and ensures their correct use. Non-automatic Terminal Endpoint Identifiers are selected by the user and therefore the responsibility for their allocation is the users. The global Terminal Endpoint Identifier is permanently allocated and is also refereed to as the broadcast Terminal Endpoint Identifier. The broadcast Terminal Endpoint Identifier is used to broadcast a message to all terminals with a given SAPI.

Operation

A request for service from the Terminal Equipment results in the layer 3 protocol of the Terminal Equipment requesting a service from the Q.921 protocol stack by sending a DL_ESTABLISH primitive. The Q.921 protocol server in the Terminal Equipment cannot offer a service unless the physical layer, layer 1, is available and so the appropriate request is made to layer 1. Before the Q.921 protocol server in the Terminal Equipment is ready to offer its services to layer 3, it must establish the multiple frames connection to its peer entity at the network side. Before the multiple frames connection has been established, the only frames that may be transmitted are unnumbered frames. The establishment procedure requires one end-point to transmit a Set Asynchronous Balanced Mode Extended (SABME) frame and the far end to acknowledge it with an Unnumbered Acknowledgment (UA) frame. Once the multiple frames connection is established, the Q.921 protocol server is able to carry layer 3 information. In this state the Q.921 protocol server's frame protection mechanisms are in use. The link access protocol operates an acknowledged service in which every information frame must be responded to by the peer entity. Providing there are no errors, all that would be observed on the bus would be the exchange of Information (I) frames and RR responses. The Q.921 protocol server is able to maintain the correct flow of information, in the face of many different error types.

Error Control

It is not very likely that a frame will disappear completely, but it is possible for frames to be corrupted by noise at the physical line. Corrupted frames are received with invalid Frame Check Sequence (FCS) values and are consequently discarded. This is done by a shift register where all bits are initially preset to 1. At the end of the protected bits, the shift register contains the remainder from the division. The 1's complement of the remainder is the FCS. At the receiver the same process is gone through, but this time the FCS is included in the division process. In the absence of transmission errors the remainder should always be 0001 1101 0000 1111. A timer is started every time a command frame is transmitted and is stopped when the appropriate response is received. This single timer is thus able to protect both the command and response frame as the loss of either will cause it to expire. When the timer expires, the Q.921 protocol server transmits a command frame with the poll bit set. This frame forces the peer to transmit a response that indicates the value held by the state variables. It is possible to tell from the value carried by the response frame whether or not the original frame was received. If the first frame was received, the solicited response frame will be the same as the lost response frame and is an acceptable acknowledgment. However, if the original frame was lost, the solicited response will not be an appropriate acknowledgment and the Q.921 protocol server knows that a retransmission is required. The Q.921 protocol server retransmits a frame three times an after that it tries to re-establish the multiple frames connection. The Receiver Not Ready (RNR) frame is used to inhibit the peer Q.921 protocol server from transmitting I frames. The FRaMe Reject frame (FRMR) may be received by a Q.921 protocol server but may not be transmitted. After the detection of a frame reject condition, the data link is reset. Returning to unnumbered frames state, the Q.921 protocol server goes to unnumbered frames state when the frames disconnect (DISC) and UA are exchanged between peers. At this point the link access protocol can no longer support the exchange of I frames and supervisory frames. The Disconnect Mode (DM) frame is an unnumbered acknowledgment and may be used in the same way as a UA frame. It is used as a response to a SABME frame if the Q.921 protocol server is unable to establish the link access protocol, and a response to a DISC if the link access protocol already has been disconnected.

Data Link Layer Maintenance System

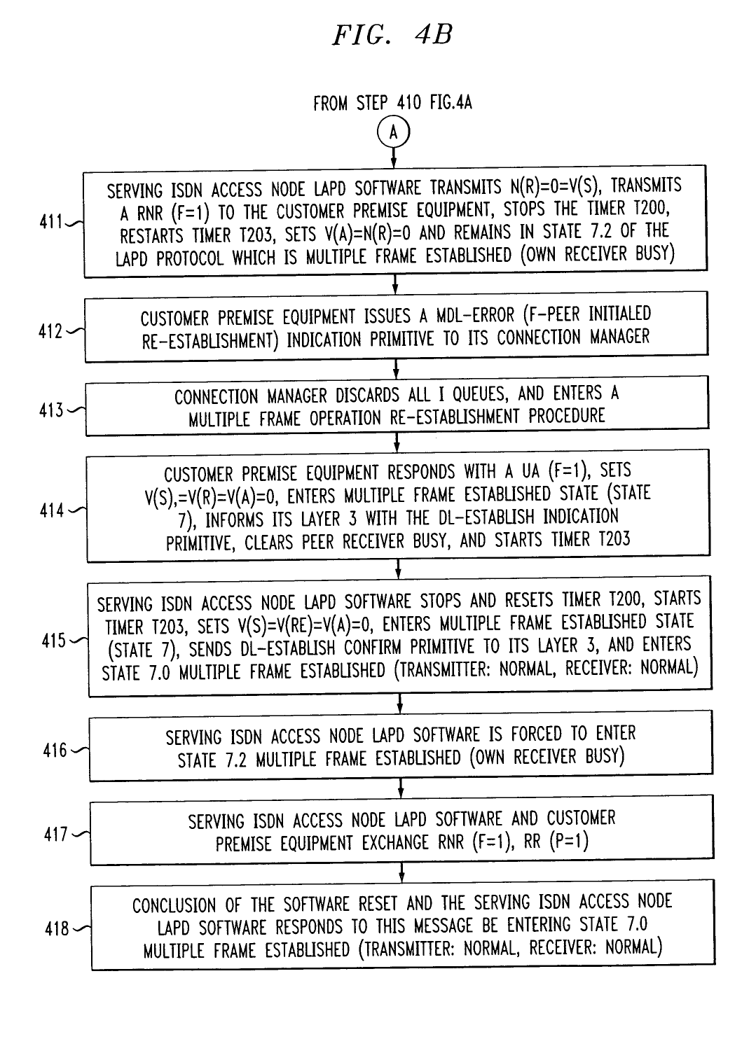

As shown in block diagram form, the Data Link Layer Maintenance System 201 is implemented as a set of program instructions that is executed by the Q.921 protocol server 202 resident in the Network Termination NT. FIGS. 4A & 4B illustrate in flow diagram form the operation of the Data Link Layer Maintenance System 201 in the telecommunications network 100 of FIGS. 1 to maintain an active data link layer for ISDN call processing during a software reset operation. The Q.921 protocol is well defined and includes specifications for operational states of the Q.921 protocol server as well as message frames, timers and the like. The following description uses the ITU-defined terminology and signaling procedures, with appropriate modifications to the procedures to implement the Data Link Layer Maintenance System 201.

At step 401, the Data Link Layer Maintenance System 201 initiates a process to manipulate the state of the Q.921 protocol server 202 of the serving ISDN Access Node 111 into state 7.2 of the Q.921 protocol, which is the multiple frame established (own receiver busy) state. At step 402, the Q.921 protocol server 202 of the serving ISDN Access Node 111 updates the persistent table, located in memory 203, that stores data which identifies the Terminal Equipment (Terminal Endpoint) (HDLC channel number, Terminal Endpoint Identification S). The Q.921 protocol server 202 of the serving ISDN Access Node 111 at step 403 is brought up in response to the Terminal Equipment initiating a software reset process. The Q.921 protocol server 202 of the serving ISDN Access Node 111 reads, at step 404, the Terminal Equipment identification data from the persistent table, located in memory 203, and the Q.921 protocol server 202 of the serving ISDN Access Node 111 enters state 7.2 of the Q.921 protocol, which is multiple frame established, own receiver busy, at step 405. At step 406, the Terminal Equipment then activates timer T203 and at step 407, the Terminal Equipment issues an RR (P=1) frame to the Q.921 protocol server 202 of the serving ISDN Access Node 111 and enters a timer recovery state (state 8). At step 408, the Q.921 protocol server 202 of the serving ISDN Access Node 111 receives the RR (P=1) frame that was transmitted by the Terminal Equipment and at step 409, determines that the state N(R) is in error. The Q.921 protocol server 202 of the serving ISDN Access Node 111 at step 410 transmits an RNR (F=1) frame to the Terminal Equipment, an MDL-ERROR frame to the connection manager (not shown) of the serving ISDN Access Node 111. The Q.921 protocol server 202 of the serving ISDN Access Node 111 also sets the variable RC=0, transmits a control message to the Terminal Equipment with SAMBE (P=1), stops the operation of timer T203, restarts timer T200 and enters the awaiting establishment state (state 5).

The Q.921 protocol server 202 of the serving ISDN Access Node 111 at step 411 transmits V(S)=N(R)=0 and an RNR frame (F=1) to the Terminal Equipment, stops the timer T200 which was restarted at step 410, restarts timer T203 which was stopped at step 410, sets V(A)=N(R)=0 and remains in state 7.2 of the LAP-D protocol, which is multiple frame established, own receiver busy. At step 412, the Terminal Equipment issues an MDL-ERROR (F-PEER, initialed reestablishment) indication primitive to its connection manager, which, at step 413, discards all I queues and enters a multiple frame operation reestablishment procedure. The Terminal Equipment at step 414 responds with an UA frame, sets V(S)=V(R)=V(A)=0. The Terminal Equipment also enters the multiple frame established state (state 7), informs its layer 3 with the DL-ESTABLISH indication primitive, clears the peer receiver busy indication and starts timer T203. At step 415, the Q.921 protocol server 202 of the serving ISDN Access Node 111 stops and resets timer T200, starts timer T203, sets V(S)=V(RE)=V(A)=0 and enters the multiple frame reestablished state (state 7). The Q.921 protocol server 202 of the serving ISDN Access Node 111 also sends the DL-ESTABLISH CONFIRM primitive to its layer 3 and enters state 7.0 of the Q.921 protocol which is multiple frame established, transmitter: normal, receiver: normal. At step 416, the Q.921 protocol server 202 of the serving ISDN Access Node 111 is forced to enter state 7.2, multiple frame established, own receiver busy.

At this juncture, the layer 3 of the LAP-D protocol executed by the Q.921 protocol server 202 maintains a stable call connection in response to the receipt of a DL-ESTABLISH indication primitive. The Q.921 protocol server 202 of the serving ISDN Access Node 111 and the Terminal Equipment exchange RNR (F=1) and RR (P=1) signals at step 417 while the software reset operation is executing. The conclusion of the software reset at step 418 is indicated by the Terminal Equipment to the Q.921 protocol server 202 of the serving ISDN Access Node 111, which responds by entering state 7.0, multiple frame established, transmitter: normal, receiver: normal. Processing of the data link layer of the communication connection is thereby returned to normal and the execution of the software reset operation is completed.

Summary

The data link layer maintenance system maintains the data link layer active in the ISDN-based Terminal Equipment and the Q.921 protocol server of the serving ISDN Access Node during the execution of a software reset process. This is accomplished by the Q.921 protocol server of the serving ISDN Access Node forcing the Terminal Equipment and the Q.921 protocol server of the serving ISDN Access Node into a predetermined stable state, which appears to be an active data link layer connection.

1. In a data communications system, a data link layer maintenance system that is operational in an ISDN Access Node and that executes the LAP-D protocol, for maintaining an existing data link layer communication session with a terminal equipment active while the terminal equipment executes a software reset operation, comprising:
data link layer state means, responsive to the initiation of a software reset operation in said terminal equipment, for forcing said terminal equipment into a predetermined active data call connection state; and
state maintenance means for exchanging call connection signals with said terminal equipment to maintain said terminal equipment into a predetermined active data call connection state.

2. The data link layer maintenance system of claim 1 wherein said data link layer state means comprises:
link session transmission means for transmitting an DL-ESTABLISH indication primitive of said LAP-D protocol to a layer 3 of the LAP-D protocol to maintain a stable call connection.

3. The data link layer maintenance system of claim 2 wherein said state maintenance means comprises:
RNR signal transmission means for transmitting an RNR (F=1) signal of said LAP-D protocol to said terminal equipment while the software reset operation is executing.

4. The data link layer maintenance system of claim 3 further comprising:
reset means, responsive to the completion of execution of said software reset operation, for disabling said RNR signal transmission means.
